(19) United States
(12) Patent Application Publication
(10) Pub. No.: US 2020/0009759 A1
(43) Pub. Date: Jan. 9, 2020

(54) METHOD FOR MAKING WOODEN STRAWS AND MOLDING SET FOR MAKING THE WOODEN STRAWS

(71) Applicant: JING-HUAN JIANG, MIAOLI COUNTY (TW)

(72) Inventor: JING-HUAN JIANG, MIAOLI COUNTY (TW)

(21) Appl. No.: 16/426,038

(22) Filed: May 30, 2019

(30) Foreign Application Priority Data
Jul. 9, 2018 (TW) 107123722

(51) Int. Cl. B26F 1/44; B27M 1/08; A47G 21/18; B27N 5/02; B27M 3/24

(52) U.S. Cl. CPC B26F 1/44; B27M 1/08; A47G 21/18; B29K 2311/14; B27M 3/24; C08L 2201/06; B27N 5/02

(57) ABSTRACT

A method for making wooden straws from a solid wood stick includes a step of providing a solid wood stick; a step of clamping the solid wood stick by a molding set, and two ends of the solid wood stick protruding beyond the molding set, and a step of drilling an axial passage through the solid wood stick by at least one machining unit to form a wooden straw. The wooden straws are bio-degradable and durable. The wooden straws do not affect beverage taste and can be manufactured in mass production. The molding set for making the wooden straws includes two dies and each die includes a groove. The solid wood stick is accommodated in the two respective grooves. At least one machining unit is used to drill an axial passage through the solid wood stick to form the wooden straw.

### BACKGROUND OF THE INVENTION

### 1.Fields of the invention

The present invention relates to a method for making wooden straws from a solid wood stick and a molding set for making the wooden straws.

### 2. Descriptions of Related Art

Plastic straws are used for enjoying beverage such as juice, tea or the like, and the plastic straws also cause many environmental problems which become a serious concern today. The plastic straws are randomly discarded to contaminate the environment and many animals are damaged by eating the straws. The plastic straws can be recycled or reused by proper cleaning methods, however, these cleaning methods require significant water and water sources are also a problem. Therefore, many country set a plan to ban the use of the plastic straw. Again, it is a big issue and is difficult to proceed the plan between balance economy and environmental impact.

There are some alternative ways to replace the plastic straws, one of which is to make straws made of bio-degradable material such as polylactic acid (PLA) made of the wheat, corns, or rice straws. Although such material as PLA is degradable much faster than the plastic, it require specific humidity, oxygen and microorganisms. To build a proper equipment or site to degrade the PLA costs a lot, and high volume of carbon dioxide will be generated. Furthermore, other additions are added into the manufacturing processes during the production of the bio-degradable straws to make the bio-degradable straws durable and can be used in different types of beverages.

Another way is the bamboo straws, however, it is difficult to control the bamboo straws to have the same size. Also, how to get sufficient sources of bamboo is a problem.

Yet another way is the metal straws. The metal has to be processed under 1500 degrees Celsius in at least four ovens, and significant of carbon dioxide will be generated. The method for making the metal straws will generate heat and involves high manufacturing cost. Besides, it is difficult to polish the inner periphery of the passage of the straws. Usually, metal straws will more or less affect the taste of the beverage.

Paper straws are also made to replace the plastic straws. The paper straws are made via many different steps such rolling, adhering, and water-proof treatment. Food grade wax is used in the steps of adhering and water-proof treatment, and the food grade wax may be combined with the food or beverage to cause concerns by the users.

Glass straws are tried to replace the plastic straws. Again, glass has to be treated under 1800 degrees Celsius in at least two ovens and significant of carbon dioxide will be generated. The glass straws are easily broken to cut the uses, and difficult to be cleaned.

The present invention intends to provide a method for making wooden straws from a solid wood stick and a molding set for making the wooden straws so as to eliminate the shortcomings mentioned above.

### SUMMARY OF THE INVENTION

The present invention relates to a method for making wooden straws from a solid wood stick, and comprises the following steps:

a step of providing a solid wood stick;

a step of clamping the solid wood stick by a molding set, two ends of the solid wood stick protruding beyond the molding set, and

a step of drilling an axial passage through the solid wood stick by at least one machining unit to form a straw.

Preferably, the molding set includes two dies and each die includes a face in which a groove is defined. The groove of each die is shaped to match the outer periphery of the solid wood stick. The solid wood stick is clamped between the two dies and accommodated in the two respective grooves of the two dies.

Preferably, a gap is formed between the two faces of the two dies when the solid wood stick is clamped between the two dies.

Preferably, the solid wood stick is a cylindrical stick.

Preferably, the arc length of each of the grooves is smaller than one half of the circumferential length of the solid wood stick.

Preferably, the method further comprises a step of cutting an inclined end of an angle to one end of the straw.

Preferably, the angle is between 15 to 35 degrees.

Preferably, two machining units respectively drill the axial passage from the two ends of the solid wood stick.

Preferably, the at least one machining unit is a debris discharge drill.

Preferably, the thickness of the straw is between 0.5 to 1.5 mm.

The present invention also provide a molding set for manufacturing a wooden straw, and the molding set comprises two dies, and each die has a face. A groove is defined in the face of each die. The groove of each die is shaped to match the outer periphery of a solid wood stick.

The advantages of the present invention are that the wooden straws are made directly from solid wood sticks without adding any addition, and the wooden straws can be directly used after being manufactured. The wooden straws are durable, acid and alkali resistant, and corrosion resistant so that they are not harmful to the users. The manufacturing cost is low so that the wooden straws can be a one-time use straw. The wooden straws can be made in mass production, and are easily degradable. Even when the wooden straws are burned, no toxic material is created.

The molding set clamps the solid wood stick firmly, so that the solid wood stick does not crack during drilling. A gap is formed between the two faces of the two dies when the solid wood stick is clamped between the two dies, so as to avoid from cracking during drilling.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the method of the present invention;

FIG. 2 is an exploded view to show the solid wood stick and the two dies of the present invention;

FIG. 3 is a perspective view to show that a gap is formed between the two dies;

FIG. 4 is a cross sectional view to show the solid wood stick and the two dies of the present invention;

FIG. 5 shows that two machining units drill the axial passage from two ends of the solid wood stick;

FIG. 6 is a cross sectional view to show that the axial passage is formed through the solid wood stick, and the thickness of the wooden straw of the present invention;

FIG. 7 is a perspective view to show that the solid wood stick are clamped between the two dies, and a gap is formed between the two dies;

FIG. 8 is a perspective view to show the wooden straw of the present invention, and

FIG. 9 is a cross sectional view to show an inclined end of an angle is formed to one end of the wooden straw of the present invention.

### DETAILED DESCRIPTION OF THE PREFERRED EMBODIMENT

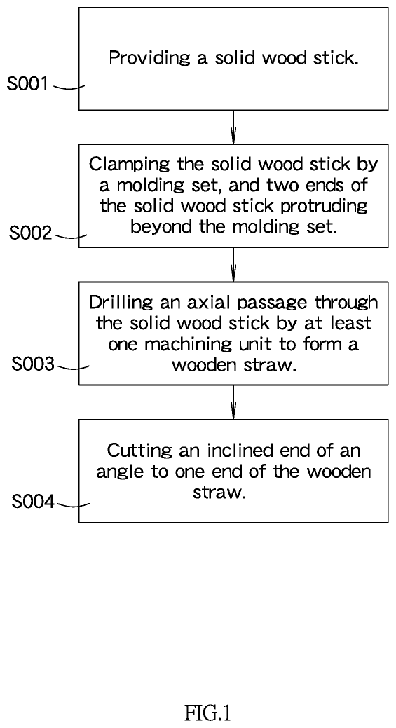

Referring to FIG. 1, the method for making wooden straws from a solid wood stick of the present invention comprises:

a step S001 of providing a solid wood stick 1;

a step S002 of clamping the solid wood stick 1 by a molding set 2, two ends of the solid wood stick 1 protruding beyond the molding set 2, and

a step S003 of drilling an axial passage 11 through the solid wood

The solid wood sticks 1 can be directly obtained from birch trees from North America or Europe without any adhering process and chemical treatment, because the birch trees are planted systematically and commercially in the areas mentioned above, and new trees are plated after being logged. Therefore, the earth environment will not be affected. The solid wood sticks 1 are obtained from one solid tree trunk and are not obtained from plywood or wood chip pressing boards. These plywood or wood chip pressing boards use adherent and chemical agent to process so that toxic material may be dissolved into beverage. The present invention uses solid wood that does not processed by any chemical treatment. The shape of the solid wood sticks 1 can be any desired shape, in this embodiment, the shape of the solid wood sticks 1 is round cylindrical. The diameter and length of the wooden straws 1′ can be set according to practical use.

The size for the existed straws may differ according to the packs or types of the beverage, for example, a small straw is used to, a normal size straw is used for beverage without adding extra material, and a big size straw is used for beverage with adding extra material.

There are no wooden straws in the market because the thickness of the plastic straws is so thin such that if the wooden straws have the same thickness as the plastic straws, the interior pressure in the wooden straws during drilling will break the wooden straws. Besides, the longer the drill is, the more eccentric rotation will be, and this will cause the diameter of the passage to be uneven, and the wall of the wooden straws is likely broken. The length of the passage for the existed straws is about 21 cm, and the existed wooden straws can only drilled a passage of 6 cm to 7 cm and the passage is not long enough for practical use.

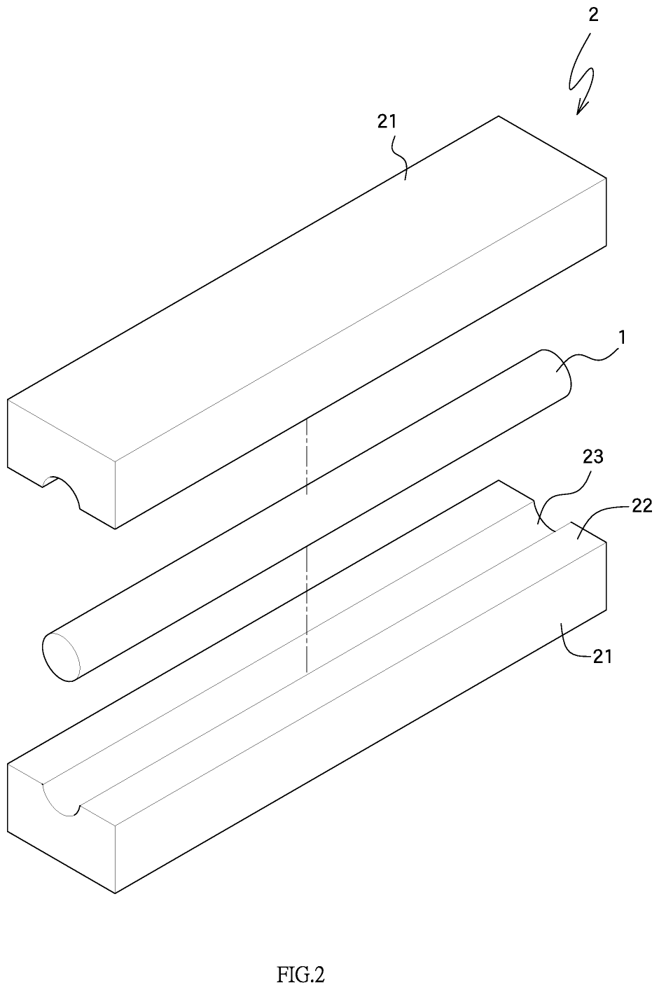

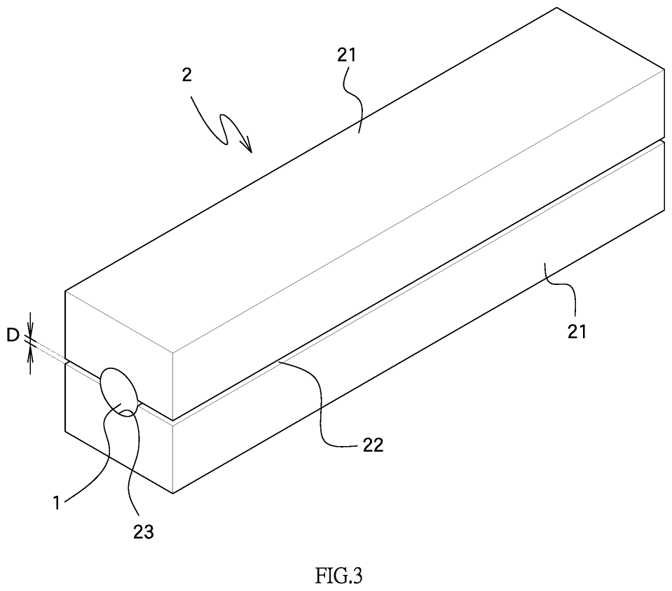

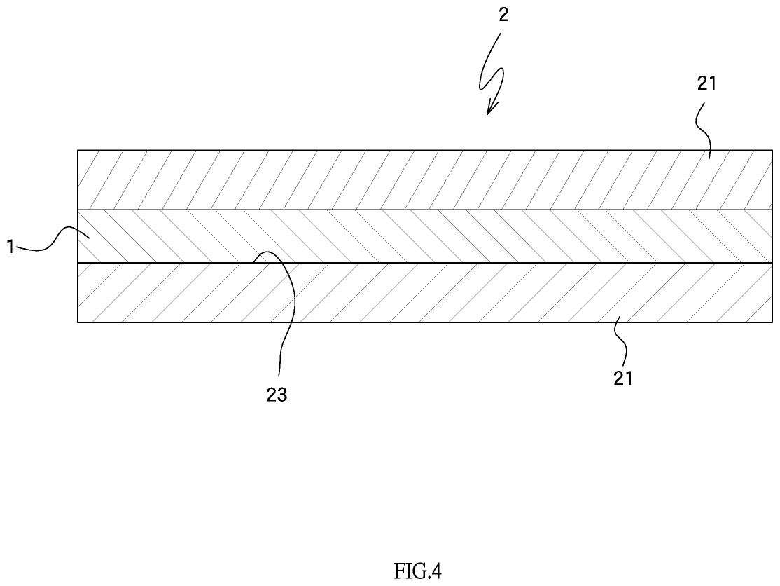

As shown in FIGS. 2 to 4, the solid wood stick 1 is clamped by a molding set 2. The two ends of the solid wood stick 1 protrude beyond the molding set 2. The molding set 2 prevents the solid wood stick 1 cracking during drilling. The molding set 2 includes two dies 21 and each die 21 includes a face 22 in which a groove 23 is defined. The groove 23 of each die 21 is shaped to match the outer periphery of the solid wood stick 1. The solid wood stick 1 is clamped between the two dies 21 and accommodated in the two respective grooves 23 of the two dies 21. A proper securing device can be used to ensure that the two dies 21 clamp the solid wood stick 1 properly and firmly.

In order to allow the pressure of the solid wood stick 1 to be released when the solid wood stick 1 is drilled, a gap “D” is formed between the two faces 22 of the two dies 21. In this embodiment, the arc length of each of the grooves 23 is smaller than one half of the circumferential length of the solid wood stick 1. In other words, the two grooves 23 cannot completely match the whole circumferential length of the solid wood stick 1 so as to form gap “D” is formed between the two faces 22 of the two dies 21. The gap “D” is substantially the same as the thickness “T” of the wooden straw 1′.

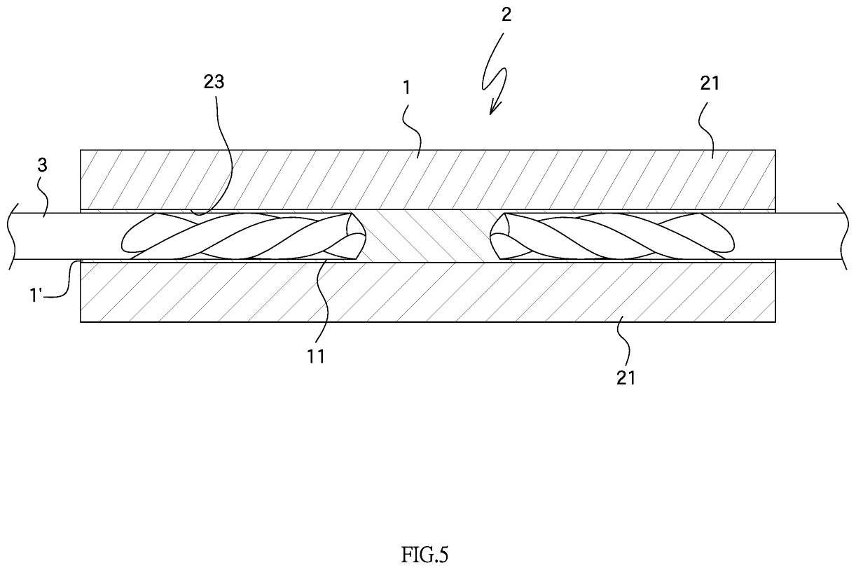

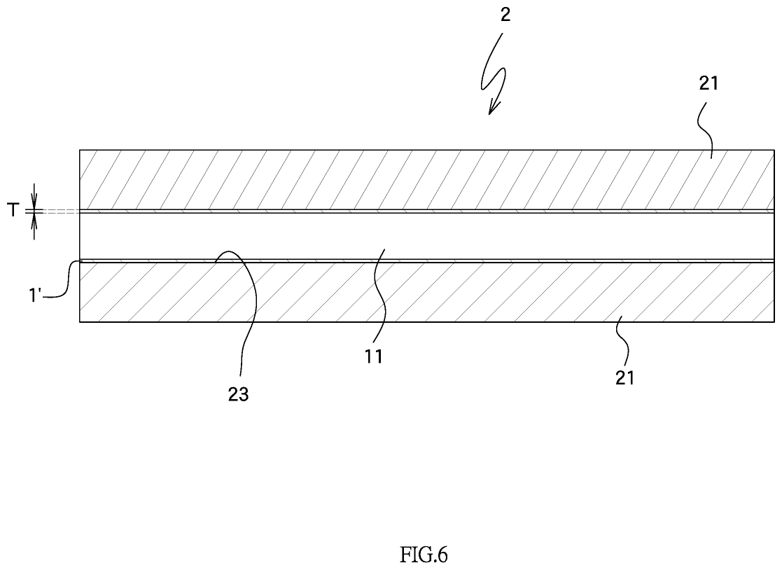

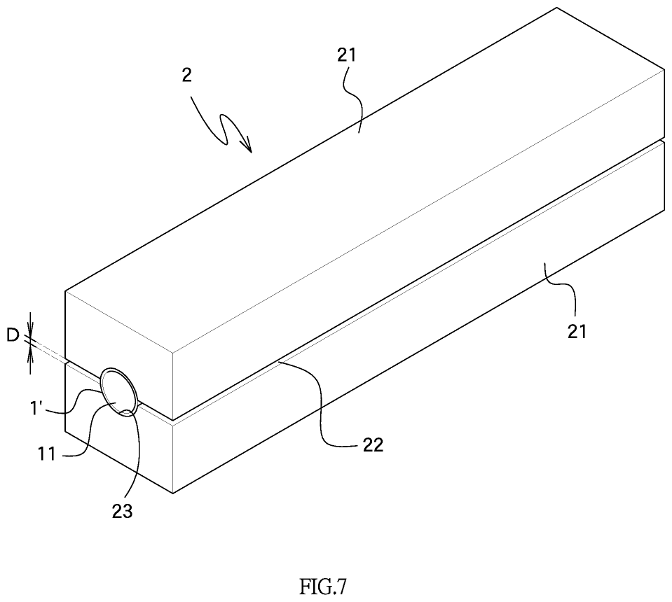

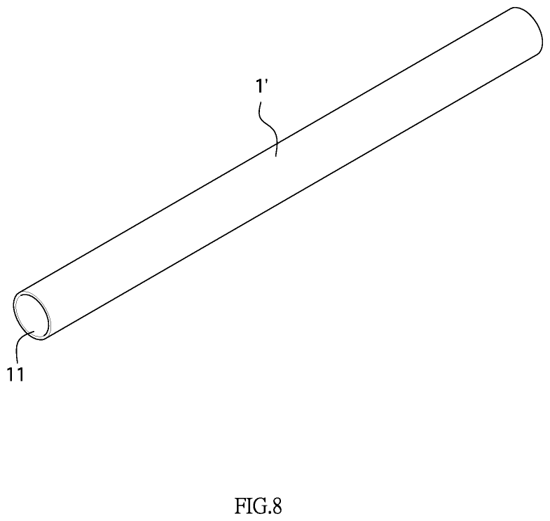

As shown in FIGS. 5 to 7, by using the at least one machining unit 3 to axially drill from one end of the solid wood stick 1, and the axial passage 11 defined through the two ends of the solid wood stick 1 to form the wooden straw 1′ as shown in FIG. 8.

In one embodiment, each machining unit 3 can be a normal drill, however, in order to increase the drilling precision and to prevent the solid wood stock 1 from being broken, the machining unit 3 is a debris discharge drill. The vibration and the pressure to the solid wood stick 1 during drilling will be released by the gap “D”. The debris discharge drill also reduces the pressure formed during process of drilling the axial passage 11. The thickness “T” of the wooden straw 1′ is between 0.5 to 1.5 mm The thickness “T” is very similar to the plastic straws.

In another embodiment, in order to increase the drilling precision and the drilling efficiency, two machining units 3 are respectively used to drill the axial passage 11 from the two ends of the solid wood stick 1. The wooden straw 1′ is formed when the two dies 21 are removed as shown in FIG. 8.

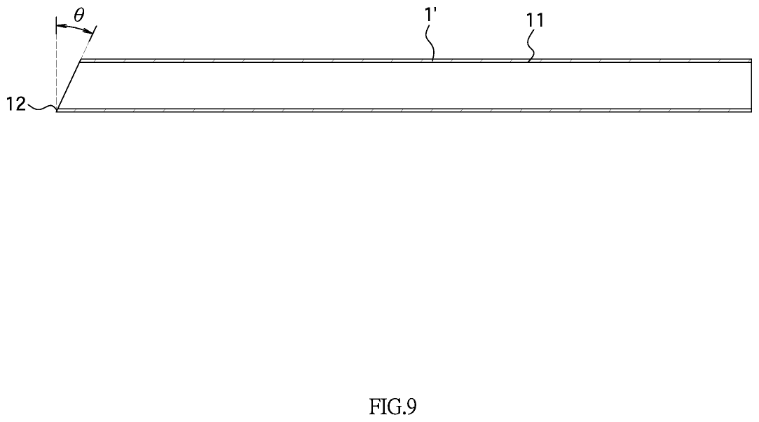

The method of the present invention may also further comprises a step S004 of cutting an inclined end of an angle 12 to one end of the wooden straw 1′ as shown in FIG. 9, so that the inclined end of the wooden straw 1′ can penetrate through the film of the beverage cup. The angle “θ” of the angle 12 is between 15 to 35 degrees. The angle “θ” does not make the inclined end not too sharp to hurt the users.

The method of the present invention does not generate carbon dioxide, no chemical addition is needed, and involves low manufacturing cost, so that the method of the present invention meets environmental requirements of different countries. Besides, the wooden straw 1′ of the present invention is directly made from solid wood so that the wooden straw 1′ of the present invention is waterproof and does not need any waterproof treatment. The wooden straw 1′ of the present invention is also durable and acid and alkali resistant so that there will be no chemical reaction to generate toxic material between the wooden straw 1′ of the present invention and the beverage even if the wooden straw 1′ of the present invention is soaked in the beverage for a period of time.

The manufacturing cost of the wooden straw 1′ of the present invention is low so that the wooden straws can be a one-time use straw. The wooden straw 1′ of the present invention does not need to be washed by using cleaning agent after use, so that it does not contaminate rivers or oceans. The wooden straws 1′ can be made in mass production, and are easily degradable within eight months to two years, and can be used as fertilizer. Even when the wooden straws 1′ are burned, no toxic material is created.

While we have shown and described the embodiment in accordance with the present invention, it should be clear to those skilled in the art that further embodiments may be made without departing from the scope of the present invention.

What is claimed is:

1. A method for making wooden straws from a solid wood stick, comprising:
a step of providing a solid wood stick;
a step of clamping the solid wood stick by a molding set, two ends of the solid wood stick protruding beyond the molding set, and
a step of drilling an axial passage through the solid wood stick by at least one machining unit to form a wooden straw.

2. The method as claimed in claim 1, wherein the molding set includes two dies and each die includes a face in which a groove is defined, the groove of each die is shaped to match an outer periphery of the solid wood stick, the solid wood stick is clamped between the two dies and accommodated in the two respective grooves of the two dies.

3. The method as claimed in claim 2, wherein a gap is formed between the two faces of the two dies when the solid wood stick is clamped between the two dies.

4. The method as claimed in claim 3, wherein the solid wood stick is a cylindrical stick.

5. The method as claimed in claim 4, wherein an arc length of each of the grooves is smaller than one half of a circumferential length of the solid wood stick.

6. The method as claimed in claim 1 further comprising a step of cutting an inclined end of an angle to one end of the wooden straw.

7. The method as claimed in claim 6, wherein the angle is between 15 to 35 degrees.

8. The method as claimed in claim 1, wherein two machining units respectively drill the axial passage from the two ends of the solid wood stick.

9. The method as claimed in claim 1, wherein the at least one machining unit is a debris discharge drill.

10. The method as claimed in claim 1, wherein a thickness of the wooden straw between 0.5 to 1.5 mm

11. A molding set for manufacturing a wooden straw, comprising:
two dies, each die having a face, a groove defined in the face of each die, the groove of each die being shaped to match an outer periphery of a solid wood stick.
